(19) United States
(12) Patent Application Publication
(10) Pub. No.: US 2004/0151126 A1
(43) Pub. Date: Aug. 5, 2004

(54) Communication system, communication control method and communication control method

(75) Inventor: Shinzo Matsubara, Kawasaki-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/724,401

(22) Filed: Dec. 1, 2003

(30) Foreign Application Priority Data
Nov. 29, 2002 (JP) 2002-348303

(51) Int. Cl. H04J 3/14

(52) U.S. Cl. 370/252; 370/338

(57) ABSTRACT

A communication control apparatus is connectable to a communication terminal through a network. The apparatus includes a transmission information holding unit configured to hold transmission information to be transmitted to the communication terminal, and a transmission-right determination unit configured to determine that the transmission information is to be transmitted to the communication terminal with a transmission right being allocated thereto if the transmission information is held in the transmission information holding unit.

### CROSS-REFERENCE TO RELATED APPLICATIONS

This application is based upon and claims the benefit of priority from the prior Japanese Patent Application No. 2002-348303, filed Nov. 29, 2002, the entire contents of which are incorporated herein by reference.

### BACKGROUND OF THE INVENTION

1. Field of the Invention

The present invention relates to a communication system that performs communication between a plurality of terminals through a network, a communication control method and a communication control terminal.

2. Description of the Related Art

In recent years, as a communication interface, wireless LANs (Local Area Networks) have rapidly spread. The standard of the wireless LAN is formulated by the IEEE 802 committee. Based on that standard, IEEE 802.11b has spread for mainly data communication in place of a wired LAN, and a rapid spread of faster IEEE 802.11a in future is also expected.

As a characteristic of the wireless LAN, the wireless LAN has extensively spread as a communication interface of personal computers because of the convenience that an information device can be located without considering wirings. As an expansion in future, use as information transfer of AV devices as well as personal computers can be expected. In this regard, a low data transfer speed, which has not been a serious problem in data communication of personal computers or the like, is pointed out.

In the present day, in the wireless LAN, as a data transfer mode standardized by the IEEE 802.11 committee, a mode such as DCF (Distribution Coordination Function) or PCF (Point Coordination Function) is stipulated in ANSI/IEEE Std 802.11 Part 11: Wireless LAN Medium Access Control (MAC) and Physical Layer (PHY) Specifications.

Further, as a mode taking the priority of data into consideration, a mode such as EDCF (Enhanced Distribution Coordination Function) or HCF (Hybrid Coordination Function) is stipulated in ANSI/IEEE Std 802.11e Part 11: Wireless LAN Medium Access Control (MAC) and Physical Layer (PHY) Specifications: Medium Access Control (MAC) Enhancements for Quality of Services (QoS).

Utilizing PCF, EDCF or HCF mentioned above enables data transfer according to the priority of information to be transmitted.

There is, e.g., Jpn. Pat. Appln. KOKAI Publication No. 8-139734 as a technique performing data transfer according to the priority of information to be transmitted. In a system disclosed in this reference, the priority is given to data transmitted from each terminal and each terminal acquires a transmission right in accordance with its priority, but the transmission right is determined by using a control channel different from a data transmission channel when acquiring the transmission right. The transmission right is determined by negotiations between the respective terminals.

Meanwhile, in the IEEE 802.11 standard, a communication terminal called a station performs communication through a communication control terminal called an access point. In this case, each station specifies the priority, and an access point gives the transmission right in accordance with the priority specified by the station, thereby realizing data transfer taking the priority into consideration.

When the station sides have information to be transmitted and the priority control is carried out and data is transmitted/received between the stations, these data transmission modes are effective. In the present day, however, there has been assumed a utilization conformation that an information device having an access point function stores information requiring a real time property such as AV information and this information is transmitted from the access point to the station.

When the information is stored in the access point, the highest priority must be given to transmission from the access point to the station. Further, when a response packet must be received by a host layer such as applications of the access point and the station, simply transmitting information from the access point by priority gives the priority to only transmission of information of the station from the access point, and processing of the host layer does not proceed because the response packet is not received from the station, which results in a problem that efficient data transfer cannot be performed in the entire application. Based on this, transmission opportunities must be given to information stored in the access point and the station that is a destination of this information, but this is not considered in PCF, EDCF and HCF mentioned above.

At this moment, when the station that has received the transmission opportunity from the access point is mounted so that it can recognize the fact that the transmission opportunity is given thereto, or when the station can select whether the transmission opportunity should be acquired, it can be considered that the given transmission opportunity is wasted unless the transmission opportunity is given from the access point taking an installation status or a setting status of the station into account, which results in non-efficient processing.

Further, since it can be considered that there are two types of information to be transmitted at the access point, i.e., information that requires real time property and information that does not require the same, higher priority must be given to the information requiring the real time property.

Furthermore, the current PCF of IEEE 802.11 is an optional function. Actually, it is hard for a user to know whether it is installed on a terminal, and there is a problem that efficient data transfer cannot be realized unless this function is installed and set in both the access point and the station. Therefore, there is required a scheme that can readily inform a user of an installation status or a setting status of a data transfer mode or change the setting of the station from the access point side.

Finally, in terms of mounting, since there is a problem that processing becomes complicated in HCF or the like, a simple and efficient algorithm is required.

Therefore, there is desired presentation of a technique that gives a transmission opportunity to the access point and a specific station by priority when information must be transmitted to its destination station from the access point, and can give priority to information requiring the real time property when there are both information such as AV information requiring the real time property and information that does not require the real time property, or inform a user of a setting status when there is a problem in setting in each station, or change settings.

### BRIEF SUMMARY OF THE INVENTION

Embodiments of the present invention may provide a communication system that realizes efficient data transfer between a plurality of terminals, a communication control method and a communication control terminal.

According to one aspect of the present invention, there is provided a communication control apparatus which is connectable to a communication terminal through a network, comprising a transmission information holding unit configured to hold transmission information to be transmitted to the communication terminal; and a transmission-right determination unit configured to determine that the transmission information is to be transmitted to the communication terminal with a transmission right being allocated thereto if the transmission information is held in the transmission information holding unit.

According to another aspect of the present invention, there is provided a communication control method for a communication control apparatus which is connectable to a communication terminal through a network, comprising causing the communication control apparatus to hold transmission information to be transmitted to the communication terminal; and determining that the transmission information is to be transmitted to the communication terminal with a transmission right being allocated thereto if the transmission information is held in the communication control apparatus.

According to still another aspect of the present invention, there is provided a communication system to which a communication terminal and a communication control apparatus are connected through a network, the communication control apparatus comprising a transmission information holding unit configured to hold transmission information to be transmitted to the communication terminal; and a transmission-right determination unit configured to determine that the transmission information is to be transmitted to the communication terminal with a transmission right being allocated thereto if the transmission information is held in the transmission information holding unit, the communication terminal comprising a communication control unit configured to recognize the transmission right transmitted from the communication control apparatus and control to transmit information to the communication control apparatus based on the transmission right.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a schematic structure of a communication system according to a first embodiment of the present invention;

FIG. 2 is a block diagram showing a function structure of an AP in the embodiment;

FIG. 3 is a block diagram showing a function structure of each STA in the embodiment;

FIG. 4 is a flowchart showing a primary operation on the AP side in the embodiment;

FIG. 5 is a block diagram showing a function structure of an AP according to second and third embodiments of the present invention;

FIG. 6 is a block diagram showing a function structure of each STA in the second, third and fourth embodiments according to the present invention;

FIG. 7 is a view showing a schematic structure of a communication system in the second, third and fourth embodiments according to the present invention;

FIG. 8 is a view showing a list of a preferred communication terminal identification information storage unit in the second, third and fourth embodiments according to the present invention;

FIG. 9 is a flowchart showing a primary operation on the AP side in the second embodiment according to the present invention;

FIG. 10 is a flowchart showing a primary operation on the AP side in the third embodiment according to the present invention; and

FIG. 11 is a block diagram showing a function structure of the AP in the fourth embodiment according to the present invention.

### DETAILED DESCRIPTION OF THE INVENTION

Embodiments of the present invention will be described below with reference to the drawings.

(First Embodiment)

A first embodiment will now be described.

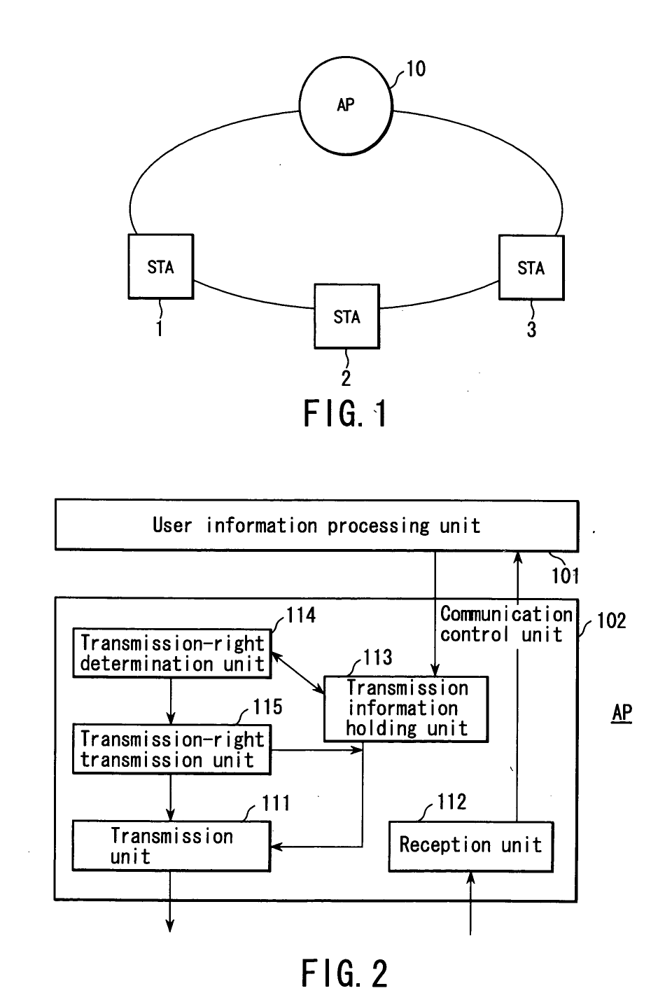

FIG. 1 is a view showing a schematic structure of a communication system in the first embodiment according to the present invention.

This communication system includes a communication control terminal called an access point (which will be referred to as an AP hereinafter) 10 and three communication terminals called stations (which will be referred to as STAs hereinafter) 1 to 3. The terminals are connected through, e.g., a wireless LAN (or a wired LAN).

In this communication system, there are a competitive period that four terminals, i.e., the AP 10 and the STAs 1 to 3 compete with each other and can acquire a communication opportunity (corresponding to a DCF period in IEEE 802.11) and a non-competitive period that the AP gives the communication opportunity to the STAs 1 to 3 (corresponding to a PCF period in IEEE 802.11). The competitive period and the non-competitive period alternately exist in a given fixed time. In the competitive period, since the respective terminals compete for the communication opportunity without a control by the AP 10 and the successfully competed terminal acquires a transmission right and transmits information, the terminals cannot necessarily evenly acquire the transmission opportunity. On the other hand, in the non-competitive period, the terminals can evenly acquire the communication opportunity under the control of the AP 10.

Conventionally, it is possible to acquire the transmission opportunity without competition when the AP sequentially gives the transmission right to each STA in the non-competitive period. Here, it is assumed that the AP also has a function as an information device that holds an information source such as AV information requiring the real time property, which is not presumed in the prior art. At this time, considering a case that the AV information of the AP is seen from the STA 1, when information is transmitted from the STA 2 and the STA 3 even in the non-competitive period, transmission/reception of information between the AP and the STA 1 is interrupted.

Thus, in this embodiment, when there is information to be transmitted from the AP 10 to the STA (hereinafter, transmission information), supply of the transmission right is considered based on this transmission information. That is, in the non-competitive period, a priority level is given to transmission of the information to be transmitted from the AP 10, and the transmission right can be preferentially given to the STA that is a destination of the transmission information.

FIG. 2 is a block diagram showing a function structure of the AP illustrated in FIG. 1.

The AP 10 shown in FIG. 2 includes a user information processing unit 101 that executes an application and a communication control unit 102 that performs a communication control.

The user information processing unit 101 corresponds to an information processing function that executes an application.

The communication control unit 102 includes: a transmission unit 111, a reception unit 112, a transmission information holding unit 113, a transmission-right determination unit 114 and a transmission-right transmission unit 115.

The transmission unit 111 transmits to a transmission path the transmission information from the transmission information holding unit 113 or a transmission right from the transmission-right transmission unit 115.

The reception unit 112 receives information transmitted from another terminal through the transmission path, and transmits reception information to the user information processing unit 101.

The transmission information holding unit 113 stores the transmission information received from the user information processing unit 101 until the transmission right is acquired in the competitive period or until the non-competitive period starts.

The transmission-right determination unit 114 determines which STA should acquire the transmission right in the non-competitive period or which transmission information should be allocated with the transmission right.

The transmission-right transmission unit 115 allocates the transmission right to the transmission information in the non-competitive period, and transmits it to the STA through the transmission unit 111. Alternatively, when there is no transmission information, the transmission-right transmission unit 115 transmits the transmission right to the STA through the transmission unit 111.

The transmission information or the transmission right to be transmitted from the transmission unit 111 to the transmission path is sent using a frame having a predetermined transmission format stipulated in IEEE 802.11. In this frame, there are prepared areas for a “frame type”, a “frame subtype” and “actual data” corresponding to the transmission information.

Here, as the frame types (corresponding to two bits), there are the following types.

00: Management Frame

01: Control Frame

10: Data Frame

Furthermore, as the frame subtypes (corresponding to four bits) of the data frame, there are the following types.

0000: Data

0001: Data+CF-Ack

0010: Data+CD-Poll

0011: Data+CF-Ack+CF-Poll

0100: Null Function (no data)

0101: CF-Ack (no data)

0110: CF-Poll (no data)

0111: CF-Ack+CF-Poll (no data)

Here, the transmission right in this embodiment corresponds to CF-Poll. Therefore, when the AP 10 transmits the transmission information and the transmission right altogether to the destination STA, “0010: Data+CF-Poll” is used. On the other hand, when there is no information to be transmitted and only the transmission right is sent, “0110: CF-Poll (no data)” is used.

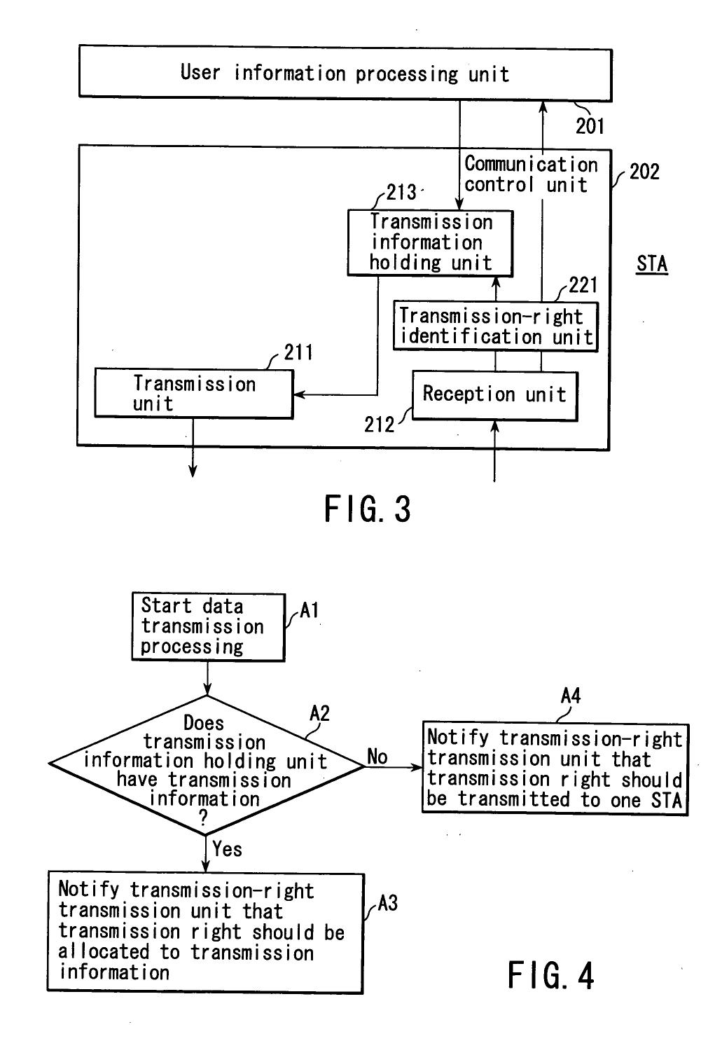

FIG. 3 is a block diagram showing a function structure of each STA illustrated in FIG. 1.

Each STA shown in FIG. 3 includes a user information processing unit 201 that executes an application and a communication control unit 202 that performs a communication control.

The user information processing unit 201 corresponds to an information processing function to execute an application.

The communication control unit 202 includes a transmission unit 211, a reception unit 212, a transmission information holding unit 213 and a transmission-right identification unit 221.

The transmission unit 211 transmits the transmission information from the transmission information holding unit 213 to the transmission path.

The reception unit 212 receives the transmission information, the transmission right or the transmission information to which the transmission right is allocated. In this case, the received transmission right is notified to the transmission information holding unit 213 through the transmission-right identification unit 221. On the other hand, the received transmission information is transmitted to the user information processing unit 201.

The transmission information holding unit 213 stores the transmission information received from the user information processing unit 201 until the transmission right is acquired in the competitive period or until the transmission right is received from the AP 10 in the non-competitive period.

When the reception unit 212 receives the transmission right or the transmission information to which the transmission right is allocated, the transmission-right identification unit 221 identifies its transmission right and notifies the transmission information holding unit 213 of a fact that the transmission right is acquired.

The operations of the AP 10 and the STAs 1 to 3 will now be described hereinafter. In particular, description will be given as to a method of performing transmission from the AP 10 to a specific STA in the non-competitive period. Here, the specific STA is assumed as the STA 1. The operation in the competitive period is eliminated because transmission from the AP 10 cannot be carried out in accordance with the priority level in the competitive period, and the transmission from the AP 10 can be carried out in accordance with the priority level because of the non-competitive period.

Incidentally, it is assumed that the AP 10 sets a time with a fixed length in activation, separates this time into the competitive period and the non-competitive period, and notifies each STA of its time distribution.

The operation of the AP 10 in the non-competitive period will first be described.

Upon receiving the transmission information from the user information processing unit 101, the communication control unit 102 stores that transmission information in the transmission information holding unit 113. When transmission of data becomes possible, the transmission information is sequentially transmitted from the transmission information holding unit 113 to the transmission unit 111 in the stored order. As a result, the transmission unit 111 transmits the transmission information to an STA.

Before the transmission information is delivered to the transmission unit 111 from the transmission information holding unit 113, the transmission-right determination unit 114 executes processing such as shown in a flowchart of FIG. 4.

That is, when the data transmission processing can be started (step A1), the transmission-right determination unit 114 determines whether the transmission information is stored in the transmission information holding unit 113 (step A2). If the transmission information is stored, the transmission-right determination unit 114 notifies the transmission-right transmission unit 115 that the transmission right should be allocated to the transmission information (step A3). On the other hand, if the transmission information is not stored, the transmission-right determination unit 114 notifies the transmission-right transmission unit 115 that the transmission right should be sent to one of a plurality of the STAs (step A4). The selection of the STA may be carried out by allocating the transmission right based on MAC addresses in the ascending order of MAC addresses or randomly allocating it.

When the AP 10 has information to be transmitted, determining the transmission right enables priority-based transmission, irrespective of the status of STAs.

On the other hand, the STA that has received the information to which the transmission right is allocated can receive the information and acquire the transmission right. As a result, when a response to the received information is required, response information can be immediately transmitted to the AP 10. For example, when an application of a host layer transmits information with the high real time property such as AV information or when the host layer needs ACK as a response confirmation, response to such a host layer can be rapidly carried out.

(Second Embodiment)

A second embodiment will now be described. Like reference numerals denote parts equal to those in the first embodiment, thereby eliminating their concrete explanation. Description will be mainly given as to a difference from the first embodiment.

As described above, in the first embodiment, it is possible to preferentially and efficiently perform transmission from the AP 10 to a specific STA by allocating the transmission right based on the transmission information of the AP 10. However, in a destination STA to which the AP 10 is to transmit the information, a case that hardware or software for understanding the transmission right is not installed or a case that the transmission right is not desired for some reason can be considered.

In such a case, even if the AP 10 side allocates the transmission right, the sufficient performance cannot be obtained. Therefore, when a mechanism used to recognize acquisition of the transmission right is installed to the STA and the transmission right is preferentially allocated to the STA that desires acquisition of the transmission right, the further effective communication can be realized.

Thus, in the second embodiment, the STA can request acquisition of the transmission right and recognize acquisition of the transmission right from the AP 10, and the AP 10 can determine whether the STA that desires acquisition of the transmission right exists and enables transmission of the transmission right to a corresponding STA based on a determination result.

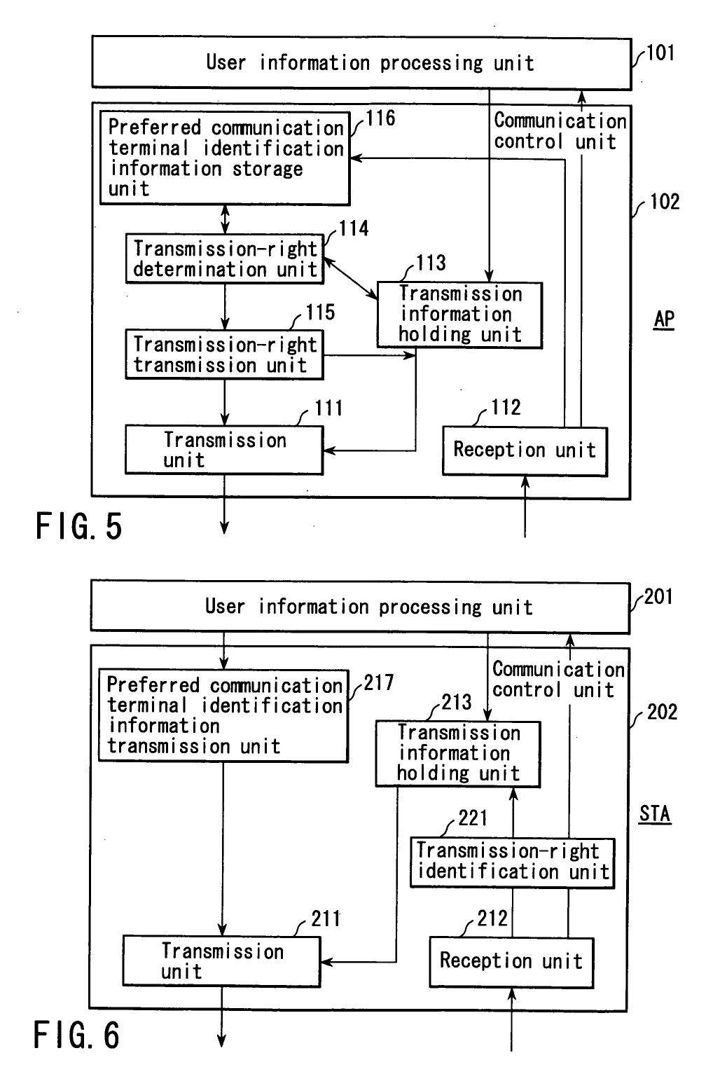

First, FIG. 5 shows a structural example of the AP 10 for realizing this function, and FIG. 6 shows a structural example of the STA.

FIG. 5 corresponds to FIG. 2 used in the first embodiment. Furthermore, FIG. 6 corresponds to FIG. 3 used in the first embodiment. Functions or operations of respective elements except a preferred communication terminal identification information storage unit 116 in FIG. 5 and a preferred communication terminal identification information transmission unit 217 in FIG. 6 are the same as those in the first embodiment.

The preferred communication terminal identification information storage unit 116 in FIG. 5 stores preferred communication terminal identification information (including identification information indicative of a communication terminal that desires acquisition of the transmission right) of the STA received by the reception unit 112.

On the other hand, when the STA desires acquisition of the transmission right, the preferred communication terminal identification information transmission unit 217 in FIG. 6 transmits the preferred communication terminal identification information including an identifier of this STA to the AP 10.

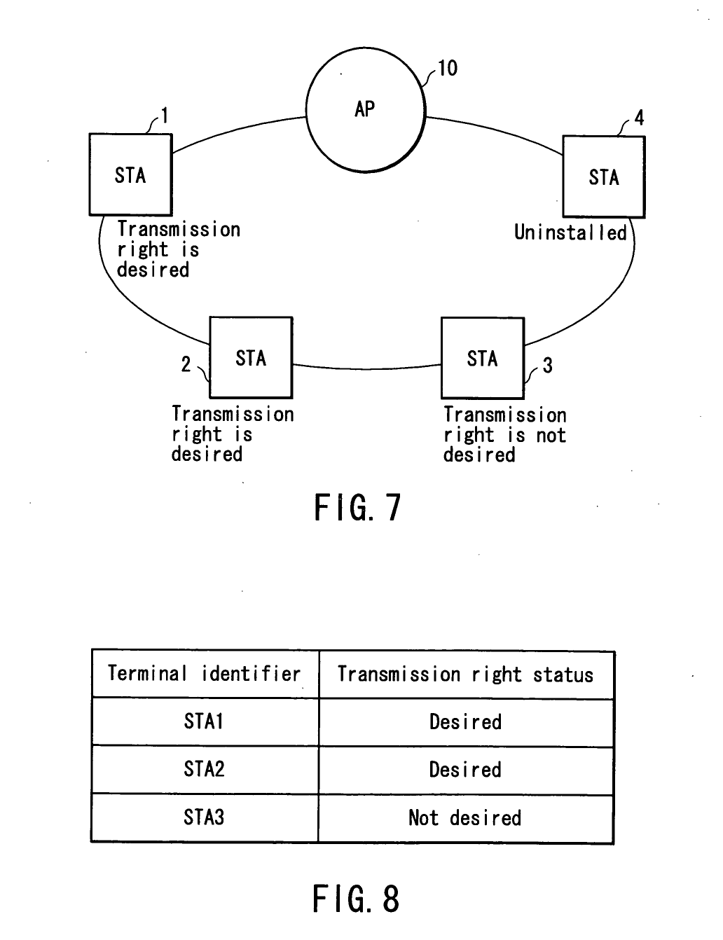

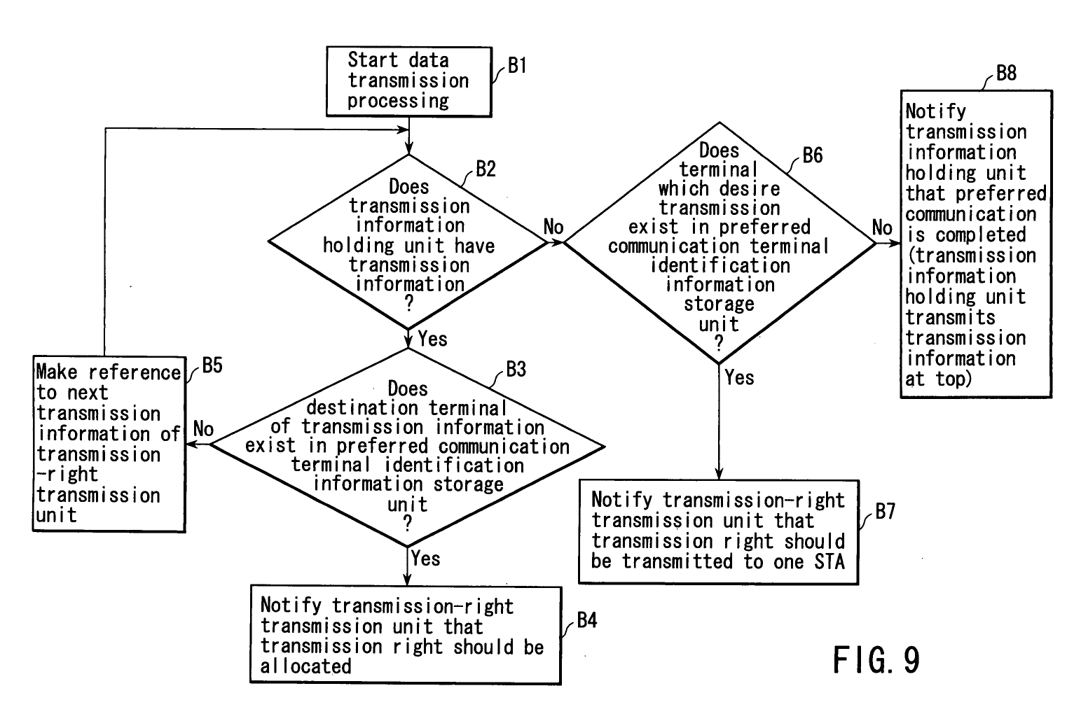

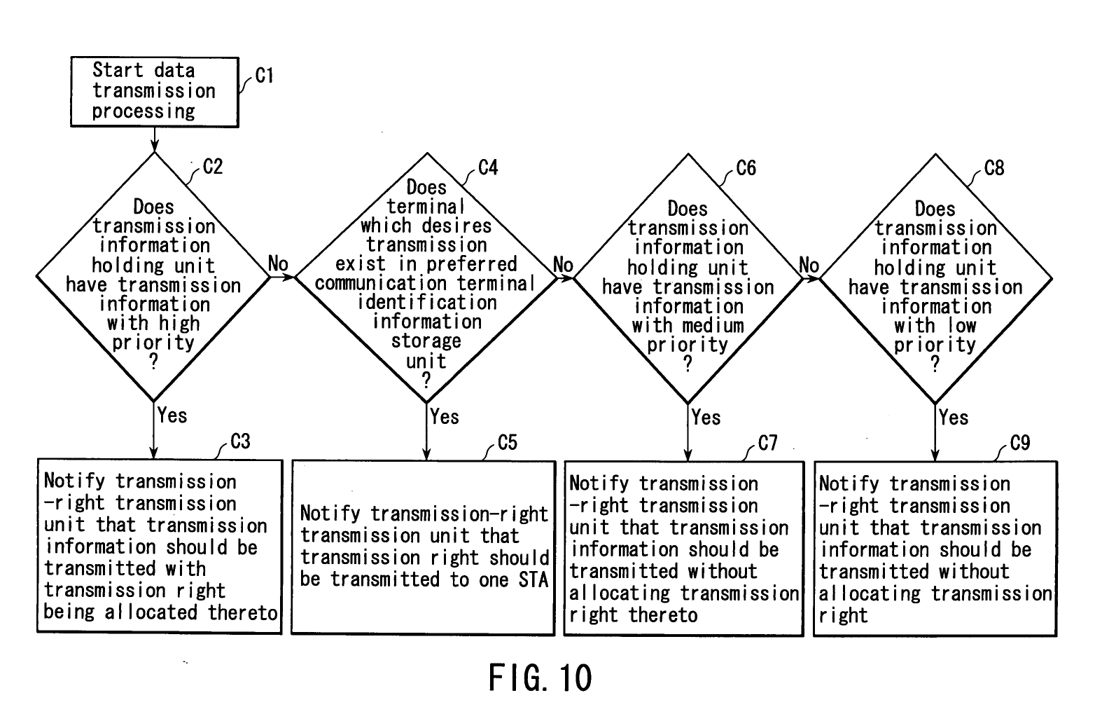

In this second embodiment, consideration is given as to a case that such a communication system as shown in FIG. 7 is formed. At this moment, it is assumed that the STA 1 and STA 2 are terminals that desire acquisition of the transmission right, the STA 3 is a terminal that does not desire acquisition of the transmission right, and the STA 4 is a terminal to which a mechanism concerning processing of the transmission right is not installed.

Description will be given as to how the preferred communication terminal identification information transmission unit 217 of the STA operates in such a situation.

It can be assumed that some STAs do not have the preferred communication terminal identification information transmission unit 217 installed therein. In FIG. 7, the STA 4 corresponds to this. In this case, the preferred communication terminal identification information is not transmitted to the AP 10 from the STA 4.

On the other hand, the preferred communication terminal identification information transmission unit 217 is installed in each of the STAs 1 to 3, and a user can specify through the user information processing unit 201 which preferred communication terminal identification information to be actually transmitted.

In FIG. 7, it is assumed that the STAs 1 and 2 transmit information including one indicative of a fact that acquisition of the transmission right to the preferred communication terminal identification information is desired to the AP 10 and the STA 3 transmits information including one indicative of a fact that acquisition of the transmission right is not desired. Moreover, when acquisition of the transmission right is not desired, the preferred communication terminal identification information may not be transmitted. Information indicative of a fact that acquisition of the transmission right is desired/not desired may be dynamically changed in the preferred communication terminal identification information by the specification from a user.

Description will now be given as to the operation on the AP 10 side that receives this preferred communication terminal identification information.

When the reception unit 112 of the AP 10 receives the preferred communication terminal identification information, the reception unit 112 transmits this information to the preferred communication terminal identification information storage unit 116. The preferred communication terminal identification information storage unit 116 determines whether a sender of this information desires acquisition of the transmission right based on the preferred communication terminal identification information.

When each STA is in, e.g., a situation shown in FIG. 7, the preferred communication terminal identification information storage unit 116 creates such a list as shown in FIG. 8 and manages it. In the example of FIG. 8, only the STA 1 and the STA 2 desire acquisition of the transmission right. An address of a sender of the information is adopted as a terminal identifier of each STA, for example. Further, since the STA 4 does not transmit the preferred communication terminal identification information, it is not written in the list shown in FIG. 8.

Here, description will be given as to how the transmission-right determination unit 114 allocates the transmission right from such a list as shown in FIG. 8 and the transmission information stored in the transmission information storage unit 113. Only the operation in the non-competitive period will be described since the transmission-right determination unit 114 operates only in the non-competitive period like the first embodiment.

In the non-competitive period, when data transmission processing can be started (step B1), the transmission-right determination unit 114 determines whether the transmission information holding unit 113 has the transmission information (step B2).

When the transmission information storage unit 113 has the transmission information, the transmission-right determination unit 114 determines whether a terminal identifier indicative of a destination of that information exists in the preferred communication terminal identification information storage unit 116 (step B3).

When the corresponding terminal identifier exists in the preferred communication terminal identification information storage unit 116, the transmission-right determination unit 114 notifies the transmission-right transmission unit 115 that the transmission right should be allocated to the transmission information and transmitted to the corresponding STA (step B4). As a result, the transmission-right transmission unit 115 allocates the transmission right to the transmission information held in the transmission information holding unit 113, and causes the transmission unit 111 to transmit the transmission information to the corresponding STA.

On the other hand, when the corresponding terminal identifier does not exist in the preferred communication terminal identification information storage unit 116, the transmission-right determination unit 114 makes reference to next transmission information of the transmission information holding unit 113 (step B5), and repeats processing from the step B2. As a result, the information can be preferentially transmitted to the STA that desires the transmission right.

Furthermore, at the step B2, when the transmission information holding unit 113 does not have the transmission information, the transmission-right determination unit 114 determines whether the preferred communication terminal identification information storage unit 116 has the terminal identifier of the STA that desires acquisition of the transmission right (step B6).

When the corresponding terminal identifier exists, the transmission-right determination unit 114 sequentially selects the terminal identifiers from the top of the list, or randomly selects the terminal identifiers, and notifies the transmission-right transmission unit 115 that the transmission right should be transmitted to the corresponding STA (step B7). As a result, the transmission-right transmission unit 115 causes the transmission unit 111 to transmit the transmission right to the corresponding STA 111.

Incidentally, when the STA having the transmission right allocated thereto does not transmit the information even though the transmission right is allocated, the subsequent allocation of the transmission right may not be performed. In this case, the AP 10 copes with this situation by rewriting a status of the transmission right in the preferred communication terminal identification information storage unit 116 of that STA to “not desired” only in this non-competitive period. Moreover, a field indicative of a temporal allocation status may be added to the list in FIG. 8.

On the other hand, at the step B6, when the preferred communication terminal identification information storage unit 116 does not have the terminal identifier of the STA that desires acquisition of the transmission right, the transmission-right determination unit 114 notifies the transmission information holding unit 113 that there is no STA that desires the transmission right (step B8). Consequently, the transmission information holding unit 113 transmits the transmission information to the transmission unit 11 in the stored order.

By doing so, since the AP 10 can allocate the transmission right to the STA in accordance with presence/absence of the transmission information or a transmission right preferred status or an installation status of the STA, the transmission right can be efficiently allocated without wastefully allocating the transmission right.

(Third Embodiment)

A third embodiment will now be described hereinafter.

In the second embodiment, it is possible to preferentially and efficiently performing transmission from the AP 10 to a specific STA by allocating the transmission right based on the transmission information of the AP 10 and the transmission right preferred status of the STA. However, since both the information that requires the real time property and the information that does not require the same exist in the transmission information held by the AP 10, it is desirable to preferentially transmit the information that requires the real time property.

Thus, in the third embodiment, determination of the order of allocating the transmission right to the transmission information is enabled by specifying a priority level to the transmission information and making reference to the priority level by the AP 10. Here, the priority may be set to two levels, i.e., a high priority and a low priority, or it may be set to more than two levels according to circumstances. In this embodiment, description will be given on the assumption that priority can be set to three levels, i.e., a high priority, a medium priority and a low priority.

Structural examples of the AP 10 and the STA that realize this function are the same as those shown in FIGS. 5 and 6 respectively used in the second embodiment.

It is to be noted that the operations of the user information processing unit 101 and the transmission information holding unit 113 in the third embodiment are different from those in the first embodiment or the second embodiment, and hence a difference between them will be described.

The user information processing unit 101 shown in FIG. 5 specifies a priority level indicative of either a high priority or a low priority in accordance with each transmission information, and issues its transmission request to the communication control unit 102. Further, the transmission information holding unit 113 stores the transmission information in accordance with each priority level specified by the user information processing unit 101.

In the third embodiment, like the second embodiment, a case that such a communication system as shown in FIG. 7 is taken into consideration. At this time, it is assumed that the STA 1 and the STA 2 are terminals that desire acquisition of the transmission right, the STA 3 is a terminal that does not desire acquisition of the transmission right and the STA 4 is a terminal in which a mechanism concerning processing of the transmission right is not installed.

In such a situation, description will be first given as to a how the transmission information holding unit 113 of the AP 10 operates.

Upon receiving a transmission request of the transmission information from the user information processing unit 101, the transmission information holding unit 113 checks a priority level of that information. When the transmission information with the high priority is received, the transmission information holding unit 113 stores the transmission information in a buffer with the high priority only when a terminal identifier of a destination STA of the transmission information is registered in the preferred communication terminal identification information storage unit 116 and a status of the transmission right indicates “desired”. In any other case (e.g., when the terminal identifier of the destination STA of the transmission information is not registered in the preferred communication terminal identification information storage unit 116 or when it is registered but the status of the transmission right indicates “not desired”), the transmission information holding unit 113 stores the transmission information in a buffer with a medium priority. When the transmission information with a low priority is received, it stores the transmission information in a buffer with a low priority.

In this manner, the transmission information holding unit 113 stores the transmission information from the user information processing unit 101 for each priority level. That is, in this embodiment, there are carried out allocations of “the high priority: the transmission information that the high priority is specified by the user information processing unit 101 and a destination STA of the information desires the transmission right”, “the medium priority: the transmission information that the high priority is specified by the user information processing unit 101 and a destination STA of the information does not desire the transmission right, or that does not exist in the preferred communication terminal identification information storage unit 116”, and “the low priority: the transmission information that the low priority is specified by the user information processing unit 101”. However, priority with more levels may be provided in accordance with a communication quality of the transmission information.

Here, description will now be given as to how the transmission-right determination unit 114 allocates the transmission right. It is to be noted that since the transmission-right determination unit 114 operates only in the non-competitive period, only the operation in the non-competitive period will be described like the first embodiment and the second embodiment.

In the non-competitive period, when the data transmission processing can be started (step C1), the transmission-right determination unit 114 determines whether the transmission information holding unit 113 has the transmission information with the high priority (step C2).

When the transmission information holding unit 113 has the transmission information with the high priority, the transmission-right determination unit 114 notifies the transmission-right transmission unit 115 that the transmission right should be allocated to the transmission information and transmitted to a corresponding STA (step C3). As a result, the transmission-right transmission unit 115 allocates the transmission right to the transmission information held in the transmission information holding unit 113, and causes the transmission unit 111 to transmit that transmission information to the corresponding STA.

On the other hand, when the transmission information holding unit 113 does not have the transmission information with the high priority, the transmission-right determination unit 114 determines whether the preferred communication terminal identification information storage unit 116 has a terminal identifier of a STA that desires acquisition of the transmission right (step C4).

When the preferred communication terminal identification information storage unit 116 has a terminal identifier of a STA that desires acquisition of the transmission right, the transmission-right determination unit 114 sequentially selects the terminal identifiers from the top of the list or randomly selects the terminal identifiers, and notifies the transmission-right transmission unit 115 that the transmission right should be transmitted to the corresponding STA (step C5). As a result, the transmission-right transmission unit 115 causes the transmission unit 111 to transmit the transmission right to the corresponding STA.

Incidentally, when the allocated STA does not transmit the information even though the transmission right is allocated, subsequent allocation of the transmission right may not be carried out. In this case, the AP 10 copes with this situation by rewriting a status of the transmission right in the preferred communication terminal identification information storage unit 116 of that STA to “not desired” only in this non-competitive period. Furthermore, a field indicative of a temporal allocation status may be additionally provided to the list shown in FIG. 8.

On the other hand, at a step C4, when the preferred communication terminal identification information storage unit 116 does not have a terminal identifier of a STA that desires acquisition of the transmission right, the transmission-right determination unit 114 determines whether the transmission information holding unit 113 has the transmission information with the medium priority (step C6).

When the transmission information holding unit 113 has the transmission information with the medium priority, the transmission-right determination unit 114 notifies the transmission-right transmission unit 115 that the transmission information with the medium priority should be transmitted to a corresponding STA without allocating the transmission right (step C7). As a result, the transmission-right transmission unit 115 causes the transmission unit 111 to transmit the transmission information with the medium priority in the storage order in the transmission information holding unit 113.

On the other hand, at a step C6, when the transmission information holding unit 113 does not have the transmission information with the medium priority, the transmission-right determination unit 114 confirms that the transmission information holding unit 113 has the transmission information with the low priority (step C8) and notifies the transmission-right transmission unit 115 that the transmission information with the low priority should be transmitted to the corresponding STA without allocating the transmission right (step C9). As a result, the transmission-right transmission unit 115 causes the transmission unit 111 to transmit the transmission information with the low priority in the storage order in the transmission information holding unit 113.

By doing so, the transmission right can be allocated to the STA in accordance with a priority level of the transmission information of the AP 10, a transmission right preferred status or an installation status of the STA, and hence allocation of the transmission right with the priority level of the transmission information of the AP 10 taken into consideration is enabled. Therefore, the preferred communication between the AP 10 and the STA can be realized, thereby transmitting the information with the high priority from the AP 10.

(Fourth Embodiment)

A fourth embodiment will now be described.

In the above-described second and third embodiments, when the STA desires acquisition of the transmission right, it is possible to preferentially and efficiently transmit information from the AP 10 to that STA. However, when the STA to which the AP 10 tries to transmit the information does not desire acquisition of the transmission right, transmission of the information to such a STA cannot be preferentially carried out.

Thus, in the fourth embodiment, when a transmission right status of a destination STA to which the AP 10 tries to transmit the information indicates “not desired”, the transmission right status is changed to “desired”. Alternatively, the AP 10 is caused to enable preferential transmission of the information by notifying the corresponding STA that the transmission right status indicates “not desired” and changing the setting if the setting can be varied.

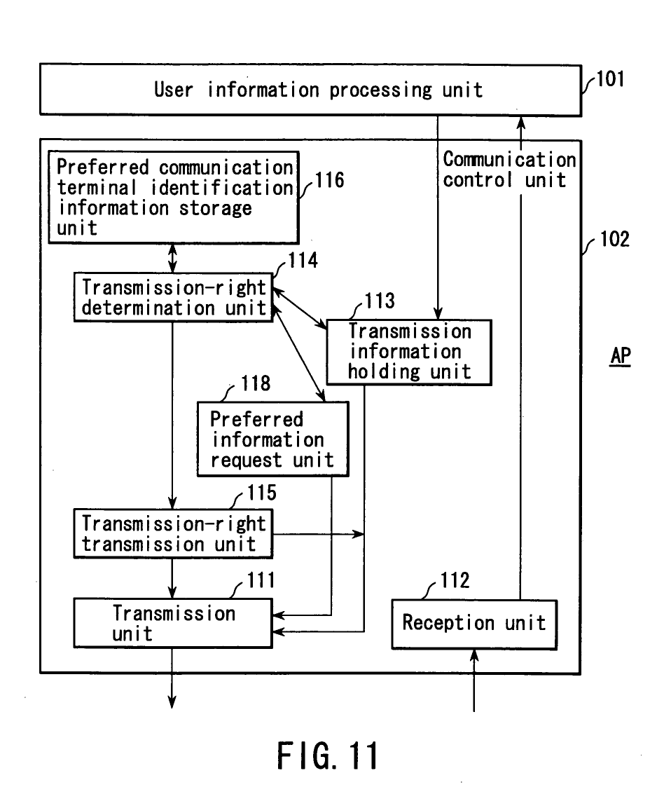

FIG. 11 shows a structural example of the AP 10 for realizing this function. The structural example of the STA is the same as that shown in FIG. 6.

FIG. 11 corresponds to FIG. 5 used in the foregoing embodiment. Functions or operations of respective elements except a preferred information request unit 118 in FIG. 11 are equal to those in the third embodiment.

The preferred information request unit 118 in FIG. 11 requests the preferred communication terminal identification information indicative of “desired” (preferred information request) with respect to the STA having a transmission right status indicative of “not desired” from the content of the transmission information of the transmission information holding unit 113 and the content of the preferred communication terminal identification information storage unit 116.

In the fourth embodiment, like the second and third embodiments, a case that such a communication system as shown in FIG. 7 is formed will be taken into consideration. At this moment, it is assumed that the STA 1 and the STA 2 are terminals that desire acquisition of the transmission right, the STA 3 is a terminal that does not desire acquisition of the transmission right, and the STA 4 is a terminal in which a mechanism concerning processing of the transmission right is not installed.

Description will be given as to how the transmission-right determination unit 114 of the AP 10 operates in such a situation.

In the non-competitive period, when the data transmission processing can be started, the transmission-right determination unit 114 determines whether the transmission information holding unit 113 has the transmission information. Here, when the transmission information indicates the high priority and a transmission right status in the preferred communication terminal identification information storage unit 116 of its destination STA indicates “not desired”, the transmission-right determination unit 114 instructs the preferred information request unit 118 to transmit the preferred information request to the corresponding STA. As a result, the preferred information request unit 118 causes the transmission unit 111 to transmit the preferred information request to the corresponding STA.

At last, processing on the STA side that receives the preferred information request in the reception unit 212 in FIG. 6 will now be described.

Upon receiving the preferred information request from the AP 10, the reception unit 112 transmits it to the user information processing unit 101. The user information processing unit 101 may output a warning indicating that a transmission right status is set to “not desired”, or the preferred communication terminal identification information transmission unit 217 may be caused to transmit information used to change the transmission right status to “desired”.

As a result, the STA that does not desire acquisition of the transmission right can be caused to desire acquisition of the transmission right, or a user can be warned about a fact that the setting that acquisition of the transmission right is not desired is provided. Setting and changing the transmission right status of the STA enable preferential communication from the AP 10 to a destination STA to which the information should be transmitted.

According to the foregoing embodiments, when information must be transmitted from the access point to a specific station as described above, the transmission opportunity is preferentially acquired to the access point and its destination station. Moreover, in a situation that there are both information that requires the real time property such as AV information and information that does not require the real time property, the priority can be given to the information that requires the real time property, and a user can be notified of a setting situation when there is a problem in setting in each station, or the setting can be changed.

As described above, according to the present invention, the efficient data transfer between a plurality of terminals can be realized.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication control apparatus which is connectable to a communication terminal through a network, comprising:
a transmission information holding unit configured to hold transmission information to be transmitted to the communication terminal; and
a transmission-right determination unit configured to determine that the transmission information is to be transmitted to the communication terminal with a transmission right being allocated thereto if the transmission information is held in the transmission information holding unit.

2. The communication control apparatus according to claim 1, wherein the transmission-right determination unit determines that the transmission right is to be transmitted to the communication terminal if the transmission information is not held in the transmission information holding unit.

3. A communication control apparatus which is connectable to a communication terminal through a network, comprising:
a transmission information holding unit configured to hold transmission information to be transmitted to the communication terminal;
an identification information storage unit configured to store identification information indicative of the communication terminal which desires acquisition of a transmission right; and
a transmission-right determination unit configured to determine that the transmission information is to be transmitted to the communication terminal with the transmission right being allocated thereto if the identification information is stored in the identification information storage unit.

4. The communication control apparatus according to claim 3, wherein the transmission-right determination unit determines that the transmission right is to be transmitted to the communication terminal transmitting the identification information if the transmission information is not held in the transmission information holding unit.

5. A communication control apparatus which is connectable to a communication terminal through a network, comprising:
a transmission information holding unit configured to hold transmission information to be transmitted to the communication terminal, a priority level being specified to the transmission information;
an identification information storage unit configured to store identification information indicative of the communication terminal which desires acquisition of a transmission right; and
a transmission-right determination unit configured to determine that the transmission information is to be transmitted to a communication terminal with the transmission right being allocated thereto if the transmission information with a high priority is held in the transmission information holding unit.

6. The communication control apparatus according to claim 5, wherein the transmission-right determination unit determines whether identification information indicative of the communication terminal which desires acquisition of the transmission right is stored in the identification information storage unit if the transmission information with the high priority is not held, and determine that the transmission right is to be transmitted to the communication terminal if the identification information is stored.

7. The communication control apparatus according to claim 5, wherein the transmission-right determination unit determines that the transmission information is to be transmitted to the communication terminal without allocating the transmission right thereto if the identification information indicative of the communication terminal which desires acquisition of the transmission right is not stored in the identification information storage unit.

8. The communication control apparatus according to claim 5, further comprising an information request unit configured to request the communication terminal of the transmission information to transmit information indicating that acquisition of the transmission right is desired, if the communication terminal does not indicate that acquisition of the transmission information is desired in the identification information storage unit.

9. A communication control method for a communication control apparatus which is connectable to a communication terminal through a network, comprising:
causing the communication control apparatus to hold transmission information to be transmitted to the communication terminal; and
determining that the transmission information is to be transmitted to the communication terminal with a transmission right being allocated thereto if the transmission information is held in the communication control apparatus.

10. The communication control method according to claim 9, further comprising:
determining that the transmission right is to be transmitted to the communication terminal if the transmission information is not held in the communication control apparatus.

11. A communication control method for a communication control apparatus which is connectable to a communication terminal through a network, comprising:
causing the communication control apparatus to hold transmission information to be transmitted to the communication terminal, and to store identification information indicative of the communication terminal which desires acquisition of a transmission right; and
determining that the transmission information is to be transmitted to the communication terminal with the transmission right being allocated thereto if acquisition of the transmission right is desired.

12. The communication control method according to claim 11, further comprising:
determining that the transmission right is to be transmitted to the communication terminal transmitting the identification information if the transmission information is not held in the communication control apparatus.

13. A communication control method for a communication control apparatus which is connectable to a communication terminal through a network, comprising:
causing the communication control apparatus to hold transmission information to be transmitted to the communication terminal, a priority level being specified to the transmission information, and to store identification information indicative of the communication terminal which desires acquisition of a transmission right; and
determining that the transmission information is to be transmitted to a communication terminal with a transmission right being allocated thereto if the transmission information with a high priority is held in the communication control apparatus.

14. The communication control method according to claim 13, further comprising:
determining whether identification information indicative of the communication terminal which desires acquisition of the transmission right is stored in the communication control apparatus if the transmission information with the high priority is not held, and determine that the transmission right is to be transmitted to the communication terminal if the identification information is stored.

15. The communication control method according to claim 13, further comprising:
determining that the transmission information is to be transmitted to the communication terminal without allocating the transmission right thereto if there is no communication terminal which desires acquisition of the transmission right.

16. The communication control method according to claim 13, further comprising:
requesting the communication terminal of the transmission information to transmit information indicating that acquisition of the transmission right is desired, if the communication terminal does not indicate that acquisition of the transmission information is desired.

17. A communication system to which a communication terminal and a communication control apparatus are connected through a network,
the communication control apparatus comprising:
a transmission information holding unit configured to hold transmission information to be transmitted to the communication terminal; and
a transmission-right determination unit configured to determine that the transmission information is to be transmitted to the communication terminal with a transmission right being allocated thereto if the transmission information is held in the transmission information holding unit,
the communication terminal comprising:
a communication control unit configured to recognize the transmission right transmitted from the communication control apparatus and control to transmit information to the communication control apparatus based on the transmission right.
